(19) United States
(12) Patent Application Publication
(10) Pub. No.: US 2019/0205925 A1
(43) Pub. Date: Jul. 4, 2019

(54) PROMOTION ALERTS BASED ON CONTINUED FORECASTING OF SCHEDULED PROMOTIONS

(71) Applicant: Target Brands, Inc., Minneapolis, MN (US)

(72) Inventors: Tony Alton Swenson, Cannon Falls, MN (US); Kristen Leigh Tegen, Saint Louis Park, MN (US)

(21) Appl. No.: 15/856,965

(22) Filed: Dec. 28, 2017

(51) Int. Cl. G06Q 30/02

(52) U.S. Cl. CPC G06Q 30/0247; G06Q 10/04; G06Q 30/0264

(57) ABSTRACT

A currently forecasted cost of a future promotion is calculated and a cost difference between the currently forecasted cost of the future promotion and a previously forecasted cost for the promotion is determined. An alert is transmitted to a user in response to the cost difference exceeding a threshold.

### BACKGROUND

Retailers offer discounts and other types of promotions in order to entice consumers to buy their products. Because promotions typically reduce the price charged for the products, retailers view promotions as having a cost equal to the difference between the original price and the promotional price times the number of products that are sold.

The discussion above is merely provided for general background information and is not intended to be used as an aid in determining the scope of the claimed subject matter. The claimed subject matter is not limited to implementations that solve any or all disadvantages noted in the background.

### SUMMARY

A currently forecasted cost of a future promotion is calculated and a cost difference between the currently forecasted cost of the future promotion and a previously forecasted cost for the promotion is determined. An alert is transmitted to a user in response to the cost difference exceeding a threshold.

In accordance with a further embodiment, a processor in a computing device executes instructions including predicting a change in cost of a scheduled future promotion and determining that the change in cost exceeds a threshold. In response to the change in cost exceeding the threshold, a user is alerted to the change in cost.

In accordance with a further embodiment, costs of future promotions are forecasted on a periodic basis. With each forecast, when a forecasted cost has changed more than a threshold amount, a user responsible for the future promotion is identified and an alert is sent to the user.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram of a system used in accordance with the various embodiments.

FIG. 2 is a flow diagram of a method of sending alerts based on changes in promotional costs.

FIG. 3 is an example user interface displaying scheduled future promotions.

FIG. 4 is an example user interface showing an alert in a news feed.

FIG. 5 is an example email showing an alert in accordance with one embodiment.

FIG. 6 provides a block diagram of an exemplary computing device that can be used to implement the various embodiments.

### DETAILED DESCRIPTION

Retailers schedule promotions weeks or months in advance. Many retailers select their promotions based on the cost of the promotion and include these costs in a promotions budget for an accounting period, such as a quarter or a year. Since the cost of a promotion is a function of the number of items sold during the promotion, changes in the number of items affected by a promotion can result in changes in the predicted cost of the promotion. For example, if a promotion offers 20% off all baseball hats, and a new baseball hat is added to the collection of hats sold by the retailer, the cost of the promotion will increase. Similarly, if one or more baseball hats are no longer available for sale, the cost of the promotion will decrease. In the past, the people responsible for scheduling and budgeting promotions were unaware when the number of products affected by the promotion changed. As a result, the people scheduling promotions could only verify that their promotion budget remained accurate by repeatedly logging into the promotion forecasting system and reviewing the forecasted costs of all promotions that were scheduled for the retailer. For large retailers having tens of thousands of products and thousands of promotions annually, this level of interaction between users and the forecasting system slowed the forecasting system.

In accordance with the various embodiments, a promotion forecaster is periodically run to update promotional costs for scheduled promotions. When changes in the items covered by the promotions cause significant changes in the promotional costs, alerts are automatically sent to the people responsible for those promotions so that the scheduled promotions may be adjusted to align the promotions with the promotion's budget. By automatically sending alerts, the people responsible for promotions do not have to continually log into the promotion system to determine if any of their promotion costs have changed significantly.

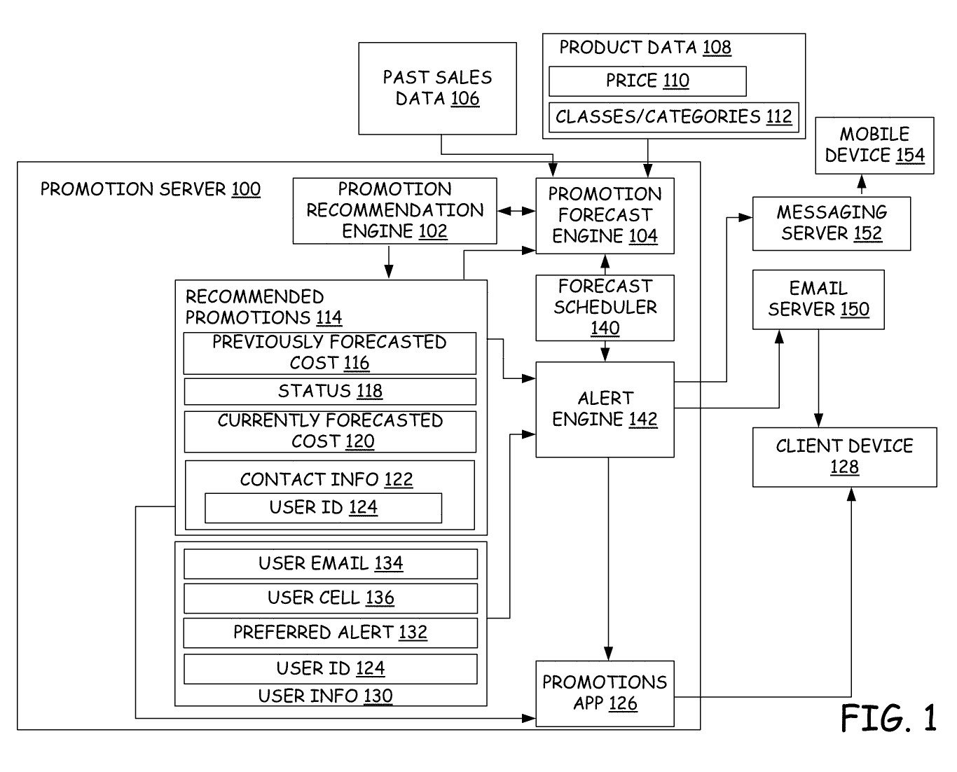

As shown in FIG. 1, a promotion server 100 executes instructions forming a promotion recommendation engine 102 and a promotion forecast engine 104. Promotion recommendation engine 102 generates possible promotions for items sold by a retailer and for each possible promotion, requests a forecast of the expected sales and the expected promotional costs associated with the promotion from promotion forecast engine 104. Promotion forecast engine 104 predicts the sales and promotional costs using past sales data 106 and product data 108 including a base price 110 for individual products and the classes/categories 112 that each product is found within. Based on the forecasted promotional costs and promotional sales, promotion recommendation engine 102 provides a list of recommended promotions 114, which includes a previously forecasted cost 116, a status 118, a currently forecasted cost 120, and contact information 122 containing a user ID 124 of a person responsible for the promotion, which is initially blank. Previously forecasted cost 116 is initially set to the first cost predicted for the promotion and is based on the number of items that are expected to be sold during the promotion times the price difference between the retail sales price and the promotional price of the items. The currently forecasted cost 120 is periodically updated as discussed further below but initially is set equal to the previously forecasted cost 116. Although not shown, recommended promotions 114 also include a list of the items covered by the promotion, the promotion start date, the promotion duration, the name of the promotion, the categories covered by the promotion, the number of items in the promotion, the channel where the offer can be redeemed, such as online or in-store, the offer type, and the offer depth.

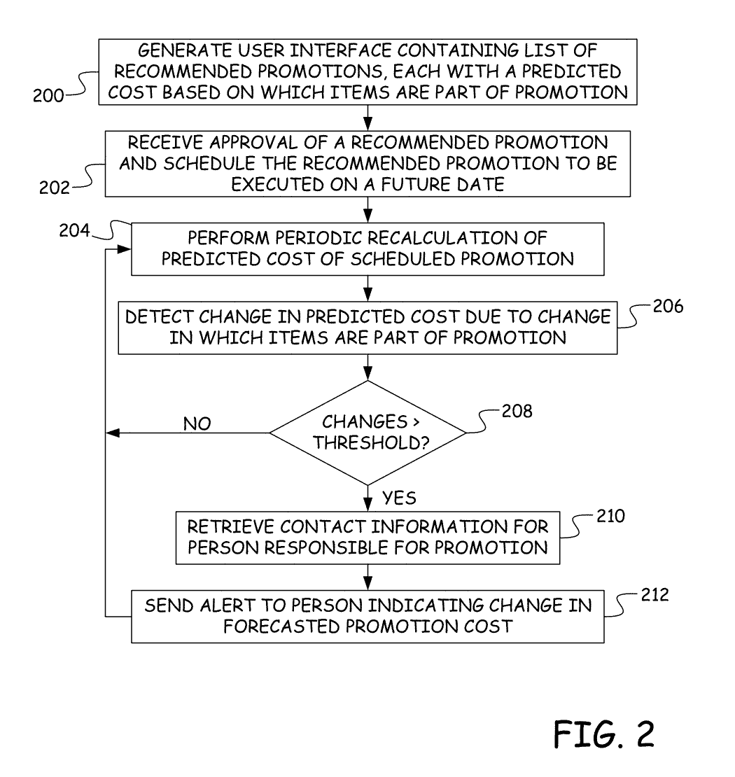

FIG. 2 provides a flow diagram of a method of scheduling recommended promotions and issuing alerts when the predicted costs of a scheduled promotion changes by more than a threshold amount. At step 200 of FIG. 2, a promotions application 126 generates a user interface containing a list of recommended promotions and their respective currently forecasted costs 120. Promotions application 126 provides its user interface to client device 128.

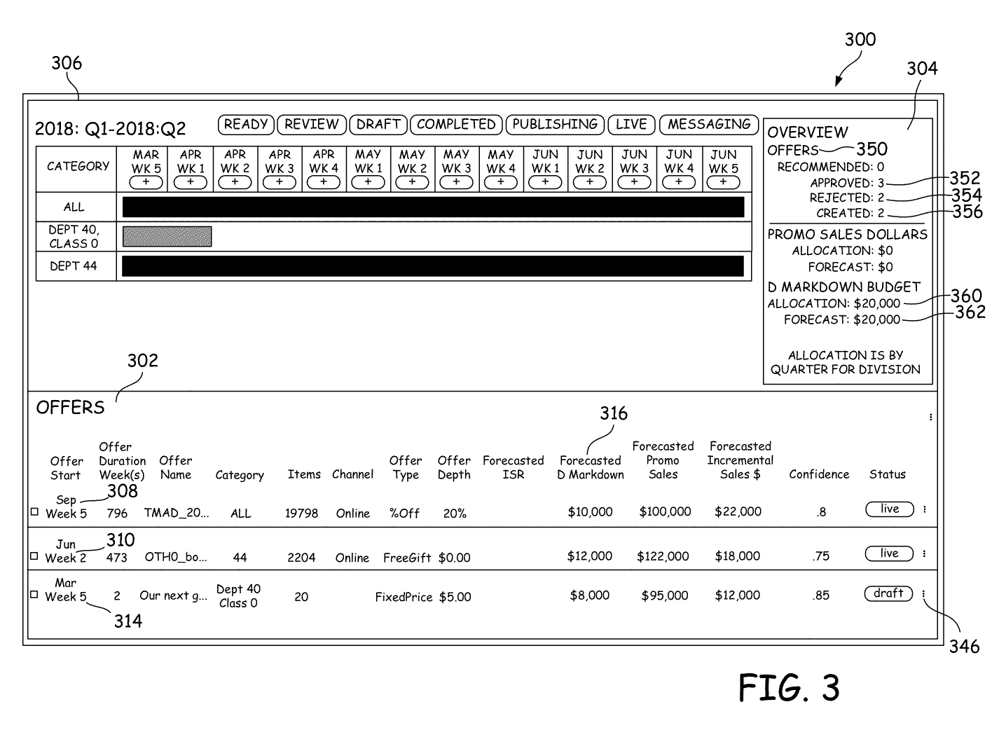

FIG. 3 provides an example of a user interface 300 generated in step 200. User interface 300 includes an offer list 302, an overview area 304, and a calendar 306. Offer list 302 includes offers recommended for a particular quarter including offers 308, 310 and 314, which are shown in separate rows. Overview area 304 provides counts for various offer statuses including counts for recommended offers 350, approved offers 352, rejected offers 354, and created offers 356. In addition, overview area 304 includes a markdown budget allocation 360 and a forecasted markdown 362 representing the total predicted promotional costs of all promotional offers that have been approved. Recommended offers that have not been approved or rejected are not included in the forecasted markdown 362. Each individual offer in offer list 302 includes a forecasted markdown 316, which contains the currently predict cost 120 of the promotion, so that the person responsible for approving the recommended promotion can see the cost of each individual promotion.

Calendar 306 shows a separate row for each approved promotion indicating the category of the promotion and the span of weeks when the promotion will be active.

At step 202, promotions application 126 receives approval of a recommended promotion and schedules the recommended promotion by changing status 118 of the recommended promotion 114. In accordance with one embodiment, user interface 300 can be used to approve a recommended promotion using a control 346, which when activated provides the option to approve or reject a recommended promotion. When a recommended promotion is first approved, the currently forecasted cost 120 for the promotion is added to forecasted markdown budget 362. In addition, the user ID of the user who approves the recommended promotion is added as user ID 124 in contact information 122. Each user ID 124 has an associated entry in user information 130 that includes a preferred alert format 132, a user email 134 and a user's cellphone number 136, for example. Preferred alert format 132 indicates how the user wishes to be alerted, for example by e-mail or text message, when a promotion cost changes by more than a threshold amount.

At step 204 of FIG. 2, a forecast scheduler 140 periodically causes promotion forecast engine 104 to recalculate the predicted cost of each scheduled recommended promotion 114. Thus, forecast scheduler 140 periodically instructs promotion forecast engine 104 to recalculate the predicted sales and costs for each promotion with a status indicating that the promotion has been scheduled. When recalculating the predicted cost of a scheduled promotion, promotion forecast engine 104 accesses product data 108 to locate all products that will be sold as part of the promotion. In accordance with one embodiment, the promotion is for a class or category of products and locating all products that will be sold as part of the promotion involves identifying all of the products that are within the class or category of the promotion. As a result, if there are any new products in the set of products that will be sold as part of the promotion or if any products have been removed from the set of products that will be sold as part of the promotion, promotion forecast engine 104 will capture this change and will use the change in products when calculating the forecasted cost of the promotion. For example, if a new product has been added, the cost of the promotion will likely increase because there will likely be more sales at the promotional price. Conversely, if a product that had previously been part of the promotion is no longer being sold, the cost of the promotion will likely decrease because there will likely be fewer sales at the promotional price. The newly forecasted cost is stored as currently forecasted cost 120 in recommended promotions 114.

At step 206, forecast scheduler 140 invokes an alert engine 142, which compares the currently forecasted cost 120 to previously forecasted cost 116 for each recommended promotion 114 to detect changes in the predicted cost, which can be due to changes in the items that are part of a promotion, for example. For each promotion that has a change in its predicted cost, alert engine 142 compares the change in the predicted cost to a threshold amount at step 208. If the change in the predicted cost is below the threshold, the process of FIG. 2 returns to step 204 to await the next recalculation of the predicted cost of schedule promotions. When a change in a predicted cost exceeds the threshold at step 208, alert engine 142 retrieves contact information for the person responsible for the promotion at step 210. In accordance with one embodiment, this contact information is retrieved from user information 130 using user ID 124 from contact information 122 of recommended promotion 114. This contact information includes the preferred alert method 132 and information required to use the preferred alert method, such as the user's email address 134 and the user's cellphone number 136. At step 212, alert engine 142 sends one or more alerts to the person indicating the change in forecasted promotion costs. In accordance with some embodiments, alert engine 142 sends the alert by sending an instruction to promotions application 126 to include the alert in a newsfeed for the user identified in contact information 122. In accordance with other embodiments, alert engine sends an e-mail to the user through an e-mail server 150. In still further embodiments, alert engine 142 sends a text message to user's mobile device 154 through a messaging server 152.

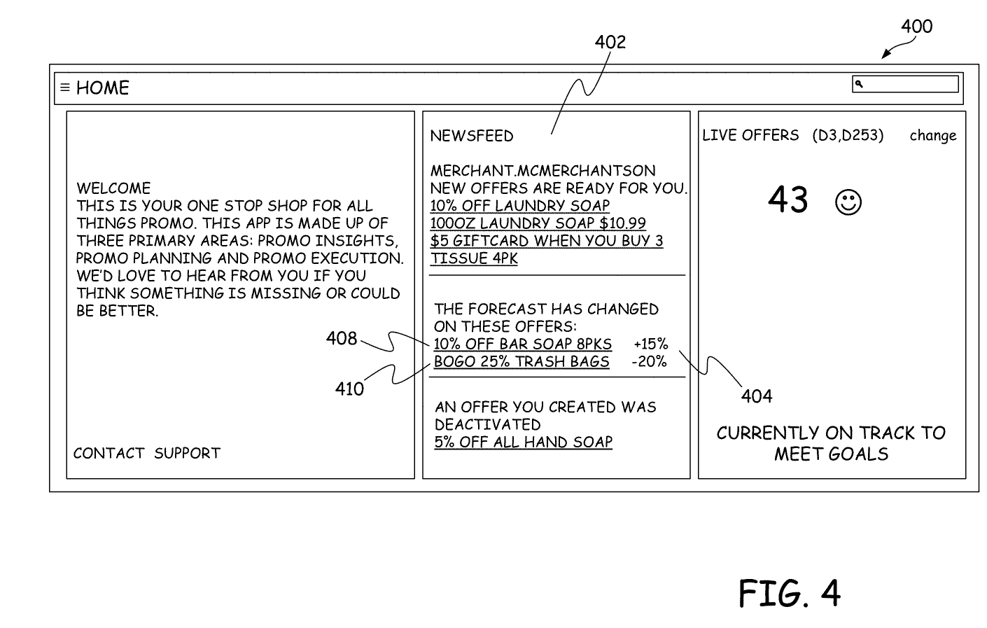

FIG. 4 provides an example user interface 400 showing a homepage with a news feed 402 that includes an alert 404. Alert 404 indicates changes in the promotional costs of two separate offers 408 and 410. For offer 408, the promotional costs have increased 15% and for offer 410, the promotional costs have decreased 20%. In accordance with one embodiment, the alerts 408 and 410 are provided as links that will cause display 300 to be shown with the selected promotions displayed in the user interface.

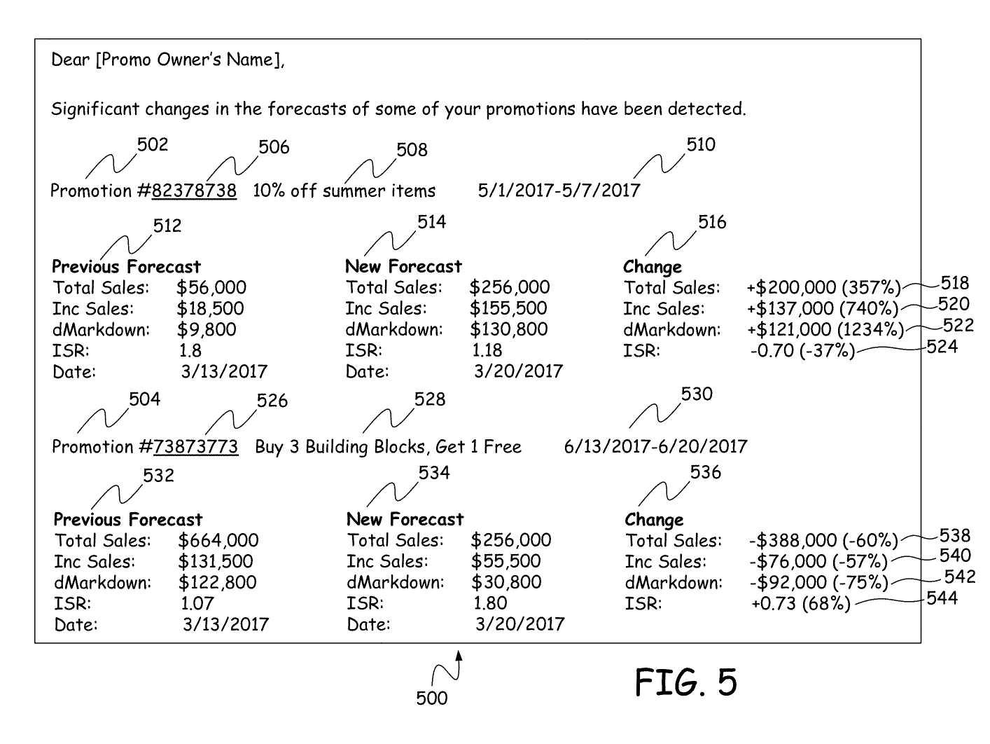

Alternatively or additionally, alert engine 142 may send an alert as an e-mail using user e-mail address 134. FIG. 5 provides an example of an alert e-mail 500 in accordance with one embodiment, which shows alerts for a promotion 502 and a promotion 504. Promotion 502 includes a promotion number 506, promotion description 508 and an active time span 510. In addition, promotion 502 includes previous forecast amounts 512, new forecast amounts 514 and changes 516. Previous forecasts 512, new forecasts 514 and changes 516 are provided for the total predicted sales 518, the incremental sales 520, the promotional costs 522 and the ISR 524 for the promotion. As shown in FIG. 5, the expected sales due to the promotion has increased dramatically by 357% causing an increase of 1234% in the promotional costs. Promotion 504 includes a promotion number 526, a promotion description 528 and a time span for the promotion 530. Promotion 504 also includes previous forecasts 532, new forecasts 534 and changes 536 for total sales 538, incremental sales 540, promotional costs 542 and ISR 544. For promotion 504, the predicted total sales has dropped 60% resulting in a decrease of the promotional costs of 75%. In accordance with one embodiment, promotion numbers 506 and 526 represent links to promotions application 126 that will cause user interface 300 to be displayed showing the selected promotion.

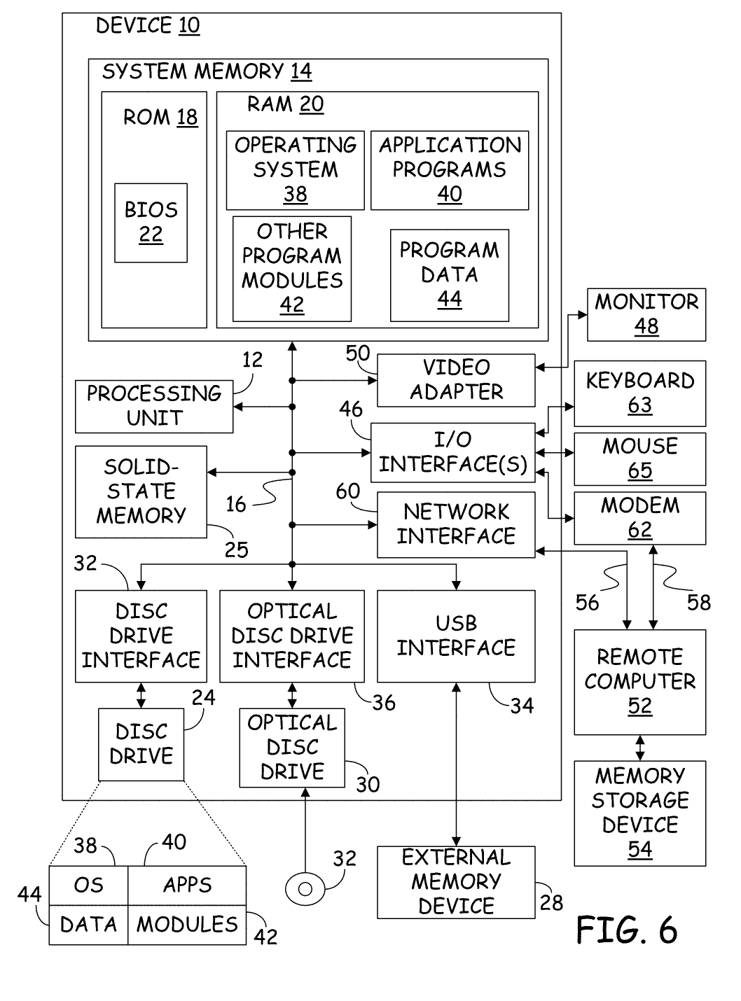

FIG. 6 provides an example of a computing device 10 that can be used as a client device or server device in the embodiments above. Computing device 10 includes a processing unit 12, a system memory 14 and a system bus 16 that couples the system memory 14 to the processing unit 12. System memory 14 includes read only memory (ROM) 18 and random access memory (RAM) 20. A basic input/output system 22 (BIOS), containing the basic routines that help to transfer information between elements within the computing device 10, is stored in ROM 18. Computer-executable instructions that are to be executed by processing unit 12 may be stored in random access memory 20 before being executed.

Embodiments of the present invention can be applied in the context of computer systems other than computing device 10. Other appropriate computer systems include handheld devices, multi-processor systems, various consumer electronic devices, mainframe computers, and the like. Those skilled in the art will also appreciate that embodiments can also be applied within computer systems wherein tasks are performed by remote processing devices that are linked through a communications network (e.g., communication utilizing Internet or web-based software systems). For example, program modules may be located in either local or remote memory storage devices or simultaneously in both local and remote memory storage devices. Similarly, any storage of data associated with embodiments of the present invention may be accomplished utilizing either local or remote storage devices, or simultaneously utilizing both local and remote storage devices.

Computing device 10 further includes a hard disc drive 24, an external memory device 28, and an optical disc drive 30. External memory device 28 can include an external disc drive or solid state memory that may be attached to computing device 10 through an interface such as Universal Serial Bus interface 34, which is connected to system bus 16. Optical disc drive 30 can illustratively be utilized for reading data from (or writing data to) optical media, such as a CD-ROM disc 32. Hard disc drive 24 and optical disc drive 30 are connected to the system bus 16 by a hard disc drive interface 32 and an optical disc drive interface 36, respectively. The drives and external memory devices and their associated computer-readable media provide nonvolatile storage media for the computing device 10 on which computer-executable instructions and computer-readable data structures may be stored. Other types of media that are readable by a computer may also be used in the exemplary operation environment.

A number of program modules may be stored in the drives and RAM 20, including an operating system 38, one or more application programs 40, other program modules 42 and program data 44. In particular, application programs 40 can include programs for implementing promotion forecast engine 104, promotion recommendation engine 102, forecast scheduler 140, alert engine 142, and promotions application 126, for example. Program data 44 may include data such as past sales data 106, product data 108, recommended promotions 114, and user information 130, for example.

Input devices including a keyboard 63 and a mouse 65 are connected to system bus 16 through an Input/Output interface 46 that is coupled to system bus 16. Monitor 48 is connected to the system bus 16 through a video adapter 50 and provides graphical images to users. Other peripheral output devices (e.g., speakers or printers) could also be included but have not been illustrated. In accordance with some embodiments, monitor 48 comprises a touch screen that both displays input and provides locations on the screen where the user is contacting the screen.

The computing device 10 may operate in a network environment utilizing connections to one or more remote computers, such as a remote computer 52. The remote computer 52 may be a server, a router, a peer device, or other common network node. Remote computer 52 may include many or all of the features and elements described in relation to computing device 10, although only a memory storage device 54 has been illustrated in FIG. 6. The network connections depicted in FIG. 6 include a local area network (LAN) 56 and a wide area network (WAN) 58. Such network environments are commonplace in the art.

The computing device 10 is connected to the LAN 56 through a network interface 60. The computing device 10 is also connected to WAN 58 and includes a modem 62 for establishing communications over the WAN 58. The modem 62, which may be internal or external, is connected to the system bus 16 via the I/O interface 46.

In a networked environment, program modules depicted relative to the computing device 10, or portions thereof, may be stored in the remote memory storage device 54. For example, application programs may be stored utilizing memory storage device 54. In addition, data associated with an application program may illustratively be stored within memory storage device 54. It will be appreciated that the network connections shown in FIG. 6 are exemplary and other means for establishing a communications link between the computers, such as a wireless interface communications link, may be used.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms for implementing the claims.

What is claimed is:

1. A computer-implemented method comprising:
calculating a currently forecasted cost of a future promotion;
determining a cost difference between the currently forecasted cost of the future promotion and a previously forecasted cost for the promotion; and
transmitting an alert to a user in response to the cost difference exceeding a threshold.

2. The computer-implemented method of claim 1 wherein the alert comprises an e-mail.

3. The computer-implemented method of claim 1 wherein the alert comprises a newsfeed entry in a promotions page.

4. The computer-implemented method of claim 1 wherein the alert comprises, the previously forecasted cost, the currently forecasted cost and the cost difference.

5. The computer-implemented method of claim 4 wherein the alert further comprises a previously forecasted sales amount, a currently forecast sales amount, and a change in the forecasted sales amount.

6. The computer-implemented method of claim 5 wherein the alert further comprises a previously forecasted incremental sales amount, a currently forecasted incremental sales amount, and a change in the forecasted incremental sales amount.

7. The computer-implemented method of claim 1 wherein the cost difference is due to an addition of an item to a set of items that are part of the promotion.

8. The computer-implemented method of claim 1 wherein the cost difference is due to a removal of an item from a set of items that are part of the promotion.

9. A computing device comprising:
a memory; and
a processor executing instructions to perform steps comprising:
predicting a change in cost of a scheduled future promotion;
determining that the change in cost exceeds a threshold; and
in response to the change in cost exceeding the threshold, alerting a user to the change in cost.

10. The computing device of claim 9 wherein alerting the user comprises sending an e-mail to the user.

11. The computing device of claim 9 wherein alerting the user comprises posting an entry in a newsfeed for the user.

12. The computing device of claim 9 wherein alerting the user comprises providing the user with a previous forecast of the cost, a current forecast of the cost and a change in the forecast cost.

13. The computing device of claim 12 wherein alerting the user comprises providing the user with a previous forecast of sales, a current forecast of sales and a change in the forecast sales.

14. The computing device of claim 9 wherein the change in cost is due to an addition of an item to a class of items involved in the scheduled future promotion.

15. The computing device of claim 9 wherein the change in cost is due to a removal of an item from a class of items involved in the scheduled future promotion.

16. A computer-implemented method comprising:
forecasting costs of future promotions on a periodic basis;
with each forecast, determining whether a forecasted cost changed more than a threshold amount since the promotion was scheduled; and
when a forecasted cost has changed more than the threshold amount, identifying a user responsible for the future promotion and sending an alert to the user.

17. The computer-implemented method of claim 16 wherein sending the alert to the user comprises adding an entry to a newsfeed for the user.

18. The computer-implemented method of claim 16 wherein sending the alert to the user comprises sending an e-mail to the user.

19. The computer-implemented method 16 wherein sending the alert comprises sending a previous forecasted cost for the promotion, a current forecasted cost for the promotion and the change in the forecasted cost.

20. The computer-implemented method of claim 16 wherein the change in forecasted cost is due to a new item being added to a class of items involved in the promotion.
